(19) United States
(12) Patent Application Publication
(10) Pub. No.: US 2007/0197162 A1
(43) Pub. Date: Aug. 23, 2007

(54) Communication relay apparatus, communication relay method, and computer product

(76) Inventors: Yoshiharu Koizumi, Kawasaki (JP); Atsushi Sekiguchi, Kawasaki (JP); Shushi Takiyama, Yokohama (JP)

Correspondence Address: KATTEN MUCHIN ROSENMAN LLP, 575 MADISON AVENUE, NEW YORK, NY, 10022-2585, US

(21) Appl. No.: 10/572,443

(22) PCT Filed: Nov. 17, 2003
(86) PCT No.: PCT/JP03/14582

§ 371 Date: Mar. 17, 2006

(51) Int. Cl. H04B 7/15

(52) U.S. Cl. 455/11.1

(57) ABSTRACT

A communication relay apparatus that relays a wireless communication for a communication device includes a wireless transmitting unit and a wireless receiving unit. the wireless transmitting unit transmits data to the communication device via a transmission antenna. The wireless receiving unit receives data from the communication device via a reception antenna of which a reception area overlaps partially with a transmission area of the transmission antenna.

### BACKGROUND OF THE INVENTION

1. Field of the Invention

The present invention relates to a technology for limiting a wireless communication area of a communication device to a predetermined area in wireless communication.

2. Description of the Related Art

A wireless local area network (LAN) allows for cable-free data communication between a terminal device and a network by rendering wireless data communication between the terminal device and the network via radio waves.

In the data communication using the radio waves, an antenna is employed on an access point that takes a role of a communication relay between the terminal device and the network.

The antenna used in the wireless LAN includes a nondirectional antenna and a directional antenna. The nondirectional antenna has a circular data communication area, as disclosed in Melco Inc., “Nondirectional antenna WLE-NDR”, [online], [searched on Sep. 12, 2003], internet <URL: http://buffalo.melcoinc.co.jp/products/catalog/item/w/wlendr/index.html>. Consequently, the nondirectional antenna allows for the data communication with any terminal device in a 360-degree field in a lateral direction.

On the other hand, the directional antenna has a data communication area that extends in a specific direction, as disclosed in Melco Inc., “Directional antenna WLE-DA”, [online], [searched on Sep. 12, 2003], internet <URL: http://buffalo.melcoinc.co.jp/products/catalog/item/w/wleda/index.html>. Thus, unlike the nondirectional antenna, the directional antenna allows for a long-distance data communication by extending the data communication area only in a specific direction.

However, in the nondirectional antenna disclosed in the former literature, the data communication area cannot be restricted to a desired area. In particular, the nondirectional antenna, which has a data communication area that expands 360 degrees in the lateral direction, has a data communication distance of about 60 meters radius around the antenna.

As a result, when performing a data communication using the nondirectional antenna, the data communication area extends beyond a desired range, which may allow a third party to wiretap or have an unauthorized access.

The directional antenna disclosed in the latter literature can extend its data communication area only in a specific direction, with a data communication distance of about 100 meters.

Thus, even with the directional antenna that expands the data communication area only in a specific direction, the coverage of the data communication area reaches outside the desired range.

In other words, because the coverage of the data communication area by way of the conventional wireless LAN is far larger than the desired area, there has been a security problem. It has therefore been an essential issue to limit the data communication area to a specific area that a user wishes.

### SUMMARY OF THE INVENTION

It is an object of the present invention to at least solve the problems in the conventional technology.

A communication relay apparatus according to one aspect of the present invention relays a wireless communication for a communication device. The communication relay apparatus includes a wireless transmitting unit that transmits data to the communication device via a transmission antenna; and a wireless receiving unit that receives data from the communication device via a reception antenna of which a reception area overlaps partially with a transmission area of the transmission antenna.

A method of relaying a wireless communication for a communication device, according to another aspect of the present invention, includes transmitting data to the communication device via a transmission antenna; and receiving data from the communication device via a reception antenna of which a reception area overlaps partially with a transmission area of the transmission antenna.

A computer-readable recording medium according to still another aspect of the present invention stores a computer program for relaying a wireless communication for a communication device. The computer program causes a computer to execute the above method according to the present invention.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining a concept of an access point according to a first embodiment of the present invention;

FIG. 2 is a functional block diagram of the access point according to the first embodiment;

FIG. 3 is a flowchart of a processing procedure for a process of the access point according to the first embodiment receiving a packet from a router;

FIG. 4 is a flowchart of a processing procedure for a process of the access point according to the first embodiment receiving a packet from a terminal device;

FIG. 5 is a schematic diagram for explaining a concept of an access point according to a second embodiment of the present invention;

FIG. 6 is a functional block diagram of the access point according to the second embodiment;

FIG. 7 is a flowchart of a processing procedure for a process of the access point according to the second embodiment receiving a packet from a router;

FIG. 8 is a schematic diagram for explaining a concept of an access point according to a third embodiment of the present invention;

FIG. 9 is a functional block diagram of the access point according to the third embodiment;

FIG. 10 is a flowchart of a processing procedure for a process of the access point according to the third embodiment receiving a packet from a router;

FIG. 11 is a flowchart of a processing procedure for a process of the access point according to the third embodiment receiving a packet from a terminal device;

FIG. 12 is a schematic diagram for explaining a concept of an access point according to a fourth embodiment of the present invention;

FIG. 13 is a functional block diagram of the access point according to the fourth embodiment;

FIG. 14 is an example of a registered-MAC-address table;

FIG. 15 is a flowchart of a processing procedure for the access point according to the fourth embodiment registering a MAC address of a terminal device;

FIG. 16 is a flowchart of a processing procedure for the access point according to the fourth embodiment sending a packet from a terminal device to a router;

FIG. 17 is a flowchart of a processing procedure for the access point according to the fourth embodiment sending a packet from a router to a terminal device;

FIG. 18 is a flowchart of a processing procedure for a MAC-address registering unit updating the registered-MAC-address table according to the fourth embodiment;

FIG. 19 is a schematic diagram for explaining a concept of an access point according to a fifth embodiment of the present invention; and

FIG. 20 is a functional block diagram of the access point according to the fifth embodiment.

### DETAILED DESCRIPTION OF THE PREFERRED EMBODIMENTS

Exemplary embodiments of the present invention will be explained in detail below with reference to the accompanying drawings.

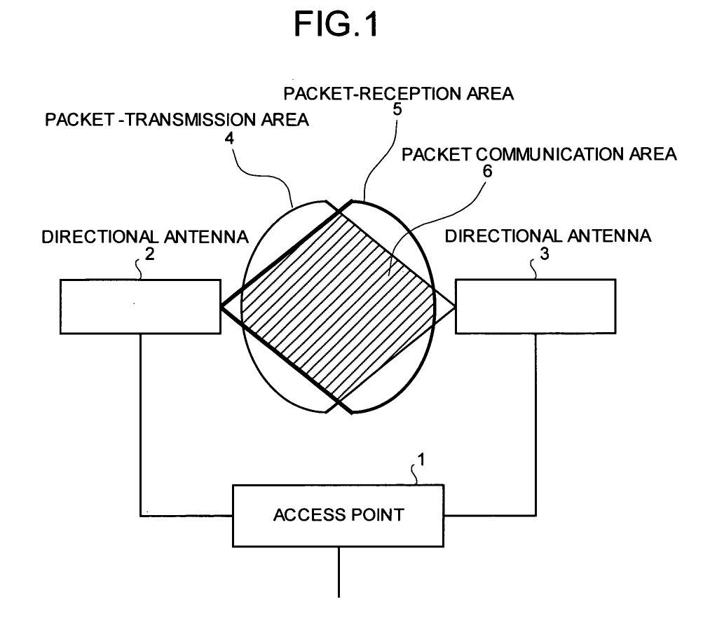

FIG. 1 is a schematic diagram for explaining a concept of an access point 1 according to a first embodiment of the present invention. The access point 1 is connected to a directional antenna 2 and a directional antenna 3. The access point 1 is also connected to a network by way of a router (not shown).

The directional antenna is utilized when data is sent to and received from a wireless communication terminal device that is located within a predetermined distance in a predetermined direction.

When receiving a packet from the network, the access point 1 sends the received packet only to the directional antenna 2, but not to the directional antenna 3. This means that the terminal device that is to receive the packet from the network has to be present in the coverage of a packet reception area 5.

When the access point 1 receives the packet from a terminal device, only the directional antenna 3 is used. This means that the terminal device that is to send the packet to the network has to be present in the coverage of a packet transmission area 4.

In other words, a terminal device that is to perform a data communication with the network has to be present in the packet communication area 6.

Hence, the access point 1 according to the first embodiment limits the data communication area to a specific area, by using the directional antenna 2 specially to send the packet to a terminal device, while using the directional antenna 3 specially to receive the packet.

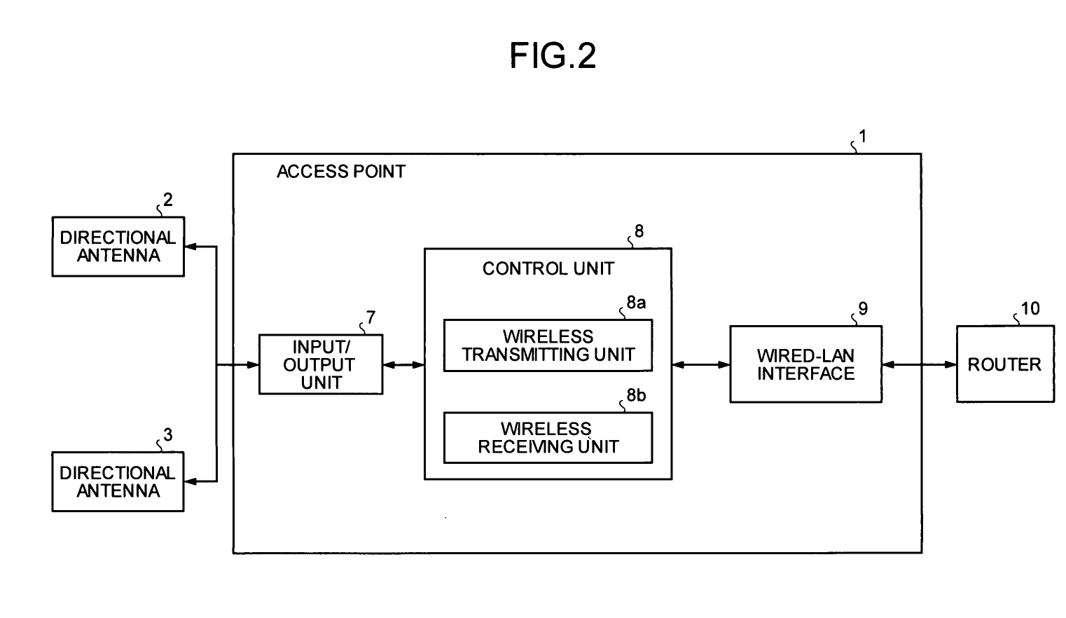

FIG. 2 is a functional block diagram of the access point 1 according to the first embodiment. The access point 1 is connected to the directional antenna 2, the directional antenna 3 and a router 10.

The access point 1 includes an input/output unit 7, a control unit 8 and a wired-LAN interface 9.

The control unit 8 includes a wireless transmitting unit 8a and a wireless receiving unit 8b. The wireless transmitting unit 8a receives the packet from the wired-LAN interface 9, and sends the received packet to the directional antenna 2 via the input/output unit 7.

The wireless receiving unit 8b receives the packet from the directional antenna 3 via the input/output unit 7, and sends the received packet to the router 10 via the wired-LAN interface 9.

The wired-LAN interface 9 sends the packet received from the router 10 to the control unit 8. The wired-LAN interface 9 sends the packet received from the control unit 8 to the router 10.

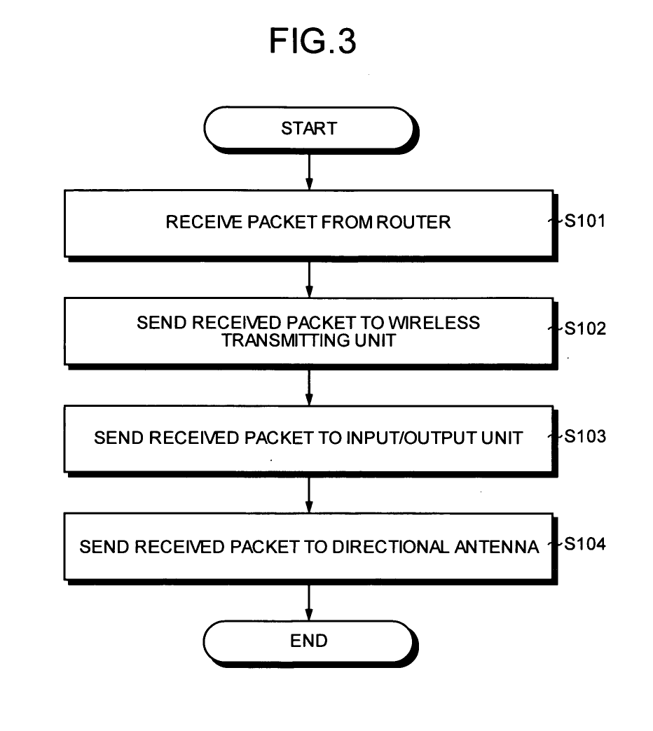

FIG. 3 is a flowchart of a processing procedure for a process of the access point 1 according to the first embodiment receiving the packet from the router 10. The wired-LAN interface 9 receives the packet from the router 10 (step S101), and sends the received packet to the wireless transmitting unit 8a (step S102).

The wireless transmitting unit 8a sends the received packet to the input/output unit 7 (step S103), and the input/output unit 7 sends the received packet to the directional antenna 2 (step S104).

In such a manner, the access point 1 sends the packet to the terminal device by using the directional antenna 2 only, when receiving the packet from the router 10.

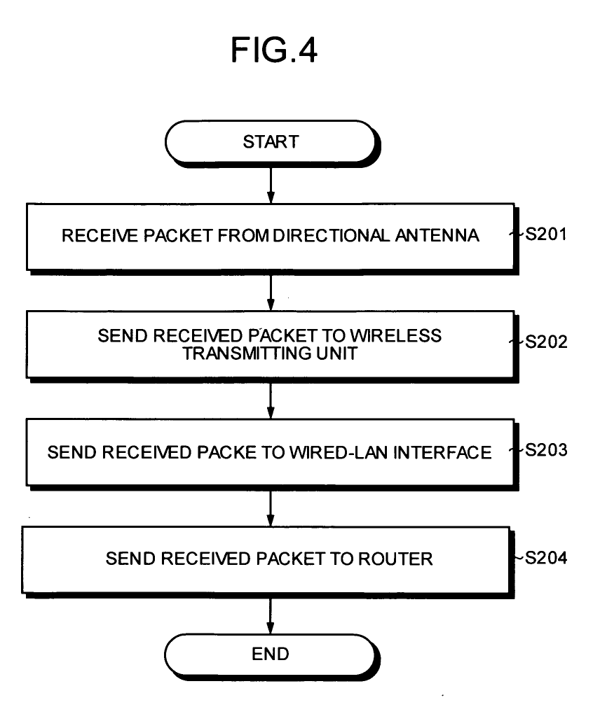

FIG. 4 is a flowchart of a processing procedure for a process of the access point 1 according to the first embodiment receiving the packet from the terminal device. The input/output unit 7 receives the packet from the terminal device via the directional antenna 3 (step S201), and sends the received packet to the wireless receiving unit 8b (step S202).

The wireless receiving unit 8b sends the received packet to the wired-LAN interface 9 (step S203), and the wired-LAN interface 9 sends the received packet to the router 10 (step S204).

The access point 1 receives the packet from the terminal device by way of the directional antenna 3 only, and sends the received packet to the router 10.

As described above, the access point 1 according to the first embodiment utilizes only the directional antenna 2 when the wireless transmitting unit 8a sends the packet received from the router 10 to the terminal device. In addition, the wireless receiving unit 8b receives the packet from the terminal device by way of the directional antenna 3 only. It is therefore necessary for the terminal device to be positioned within the packet communication area 6 to perform the wireless data communication with the network.

Hence, the packet communication area can be limited to an area that the user desires by adopting the directional antenna 2 and the directional antenna 3. This can prevent a third party from wiretapping and having an unauthorized access, and improve security in the wireless communication.

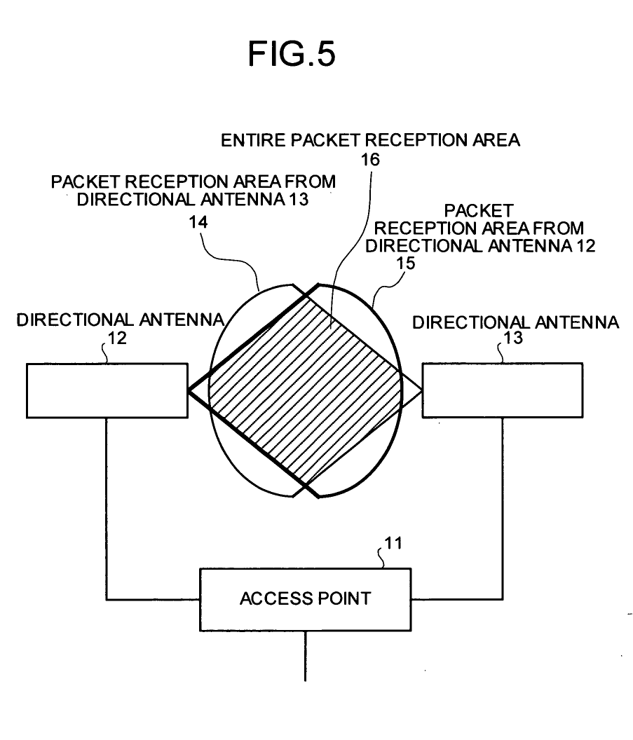

FIG. 5 is a schematic diagram for explaining a concept of an access point 11 according to a second embodiment of the present invention.

The access point 11 is connected to a directional antenna 12 and a directional antenna 13. The access point 11 is also connected to a network via a router (not shown).

The access point 11 uses the directional antenna 12 and the directional antenna 13 alternately, when sending a packet received from the router to a terminal device.

Thus, the terminal device cannot receive all the packets unless it is positioned within an entire packet reception area 16 that includes the overlapping area of a packet reception area 15 for the packet from the directional antenna 12 and a packet reception area 14 for the packet from the directional antenna 13.

In other words, the data communication area can be limited to a specific area that the user desires by using the directional antenna 12 and the directional antenna 13 alternately when sending data to a predetermined terminal device.

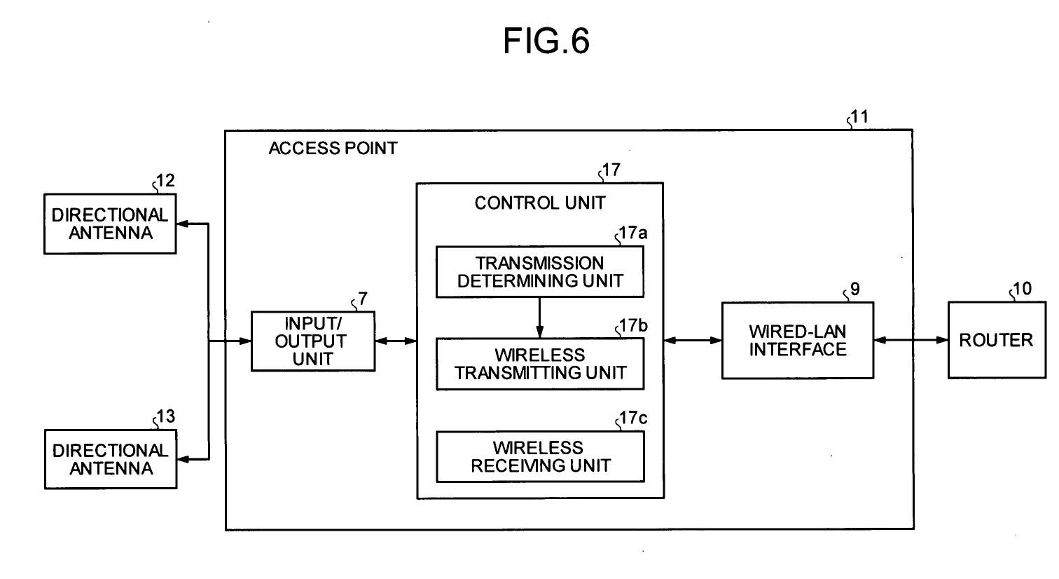

FIG. 6 is a functional block diagram of the access point 11 according to the second embodiment. The access point 11 is connected to the directional antenna 12, the directional antenna 13, and a router 10.

The access point 11 includes a control unit 17. Since the rest of the structure and operation of the access point 11 is the same as the access point 1 described in the first embodiment, the same reference numerals are adopted for the same structural elements, and the explanation is omitted.

The control unit 17 includes a transmission determining unit 17a, a wireless transmitting unit 17b, and a wireless receiving unit 17c. The transmission determining unit 17a determines a directional antenna to be used so that the packet received from the router 10 is sent alternately to the directional antenna 12 and the directional antenna 13, and sends a result of the determination to the wireless transmitting unit 17b.

The wireless transmitting unit 17b sends the packet sent from the router 10 to the directional antenna 12 or the directional antenna 13 via the input/output unit 7, based on the result of the determination by the transmission determining unit 17a.

The wireless receiving unit 17c receives the packet sent from the terminal device by way of the directional antenna 12 or the directional antenna 13, and sends the received packet to the router 10 via the wired-LAN interface 9.

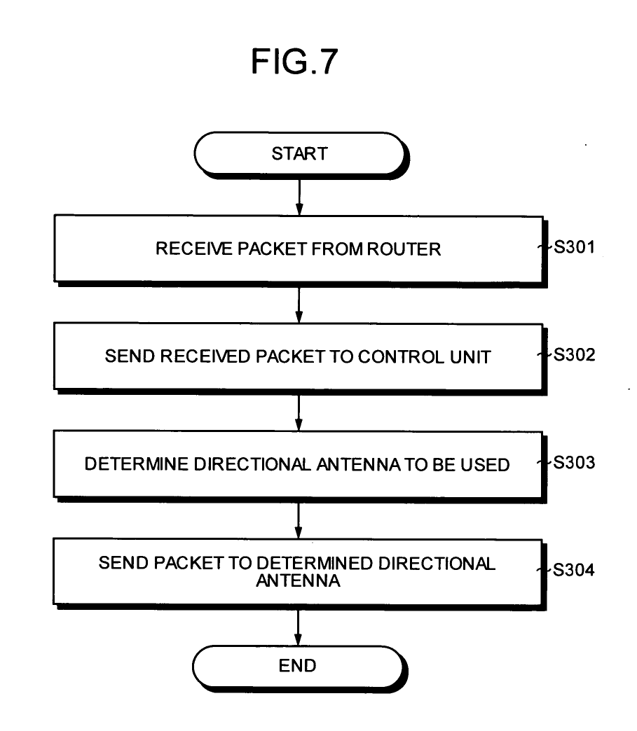

FIG. 7 is a flowchart of a processing procedure for a process of the access point 11 according to the second embodiment receiving the packet from the router 10.

The wired-LAN interface 9 receives the packet from the router 10 (step S301), and sends the received packet to the control unit 17 (step S302). The transmission determining unit 17a determines a directional antenna to be used so that packet is sent alternately to the directional antenna 12 and the directional antenna 13 (step S303). The wireless transmitting unit 17b sends the packet to the directional antenna determined by the transmission determining unit 17a (step S304). The process indicated in FIG. 7 is repeated every time the access point 11 receives the packet.

By determining a directional antenna to be used so that the packet is sent alternately to the directional antenna 12 and the directional antenna 13 at step S303, if the directional antenna 12 is used at a previous time when the packet is sent, the directional antenna 13 is to be used next, and if the directional antenna 13 is used at the previous time when the packet is sent, the directional antenna 12 is to be used next.

As described above, the access point 11 according to the second embodiment receives the packet from the router 10, and the transmission determining unit 17a determines a directional antenna to be used so that the received packet will be sent alternately to the directional antenna 12 and the directional antenna 13. The wireless transmitting unit 17b sends the packet to the directional antenna 12 or the directional antenna 13, based on the determination made by the transmission determining unit 17a. In other words, the terminal device cannot perform the data communication with the network unless it is located within the entire packet reception area 16.

As a result, the data communication area can be limited to a specific area by utilizing the directional antenna 12 and the directional antenna 13 alternately, and security can be improved in the wireless communication.

The packet is used as an example in the second embodiment. However, the present invention is not limited to this scheme. The structure may be such that a piece of data having a predetermined size is received, the received data is divided, and the divided data is sent alternately to the directional antenna 12 and the directional antenna 13.

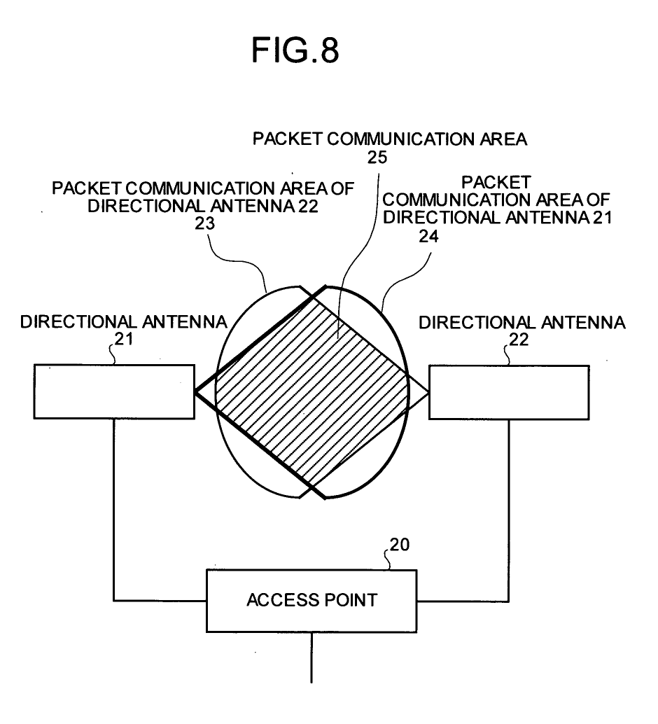

FIG. 8 is a schematic diagram for explaining a concept of an access point 20 according to a third embodiment of the present invention.

The access point 20 is connected to a directional antenna 21 and a directional antenna 22. The access point 20 is also connected to a network via a router (not shown).

The access point 20 uses the directional antenna 21 but not the directional antenna 22 when performing a data communication relay between the router and a predetermined terminal device. Only when the packet passing the access point 20 reaches a predetermined size, the antenna is switched to the directional antenna 22, and the directional antenna 21 is deactivated.

In addition, when the packet passing the access point 20 reaches the predetermined size after the antenna in use is switched to the directional antenna 22, the antenna is switched back to the directional antenna 21, and the directional antenna 22 is inactivated.

In other words, the directional antennas are switched every time the packet that passes the access point 20 reaches the predetermined size. Therefore, the terminal device can perform the data communication with the network only when it is positioned within a packet communication area 25 where a packet communication area 24 of the directional antenna 21 and a packet communication area 23 of the directional antenna 22 overlap each other.

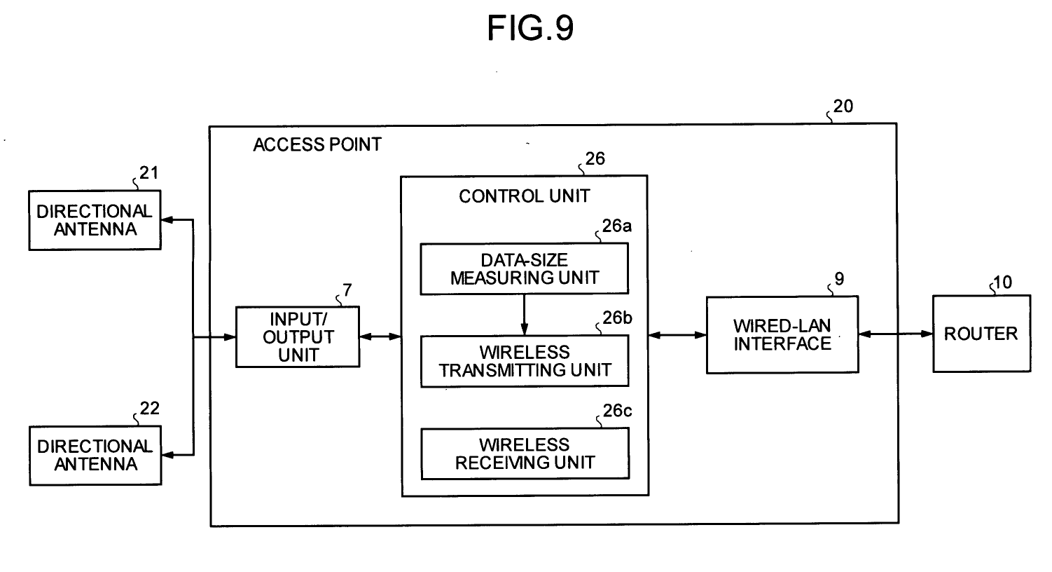

FIG. 9 is a functional block diagram of the access point 20 according to the third embodiment. The access point 20 is connected to the directional antenna 21, the directional antenna 22, and a router 10.

The access point 20 includes a control unit 26. Since the rest of the structure and operation of the access point 20 is the same as the access point 1 described in the first embodiment, the same reference numerals is adopted for the same structural elements, and the explanation is omitted.

The control unit 26 includes a data-size measuring unit 26a, a wireless transmitting unit 26b, and a wireless receiving unit 26c. The data-size measuring unit 26a measures a size of the packet that is sent from the router 10 to the directional antenna 21 or the directional antenna 22 and a size of packet that is sent from the terminal device to the router 10.

The data-size measuring unit 26a sends a command to switch the directional antenna currently used each time the measured size of the packet reaches a predetermined level to the wireless transmitting unit 26b and the wireless receiving unit 26c.

The wireless transmitting unit 26b and the wireless receiving unit 26c use the directional antenna 21 at the beginning when carrying out the data transmission and reception between the terminal device and the router 10. When receiving the command from the data-size measuring unit 26a to switch the directional antenna currently used, the wireless transmitting unit 26b and the wireless receiving unit 26c switch the antenna to the directional antenna 22.

In other words, the wireless transmitting unit 26b and the wireless receiving unit 26c use the directional antenna 22 when carrying out the data communication between the terminal device and the router 10.

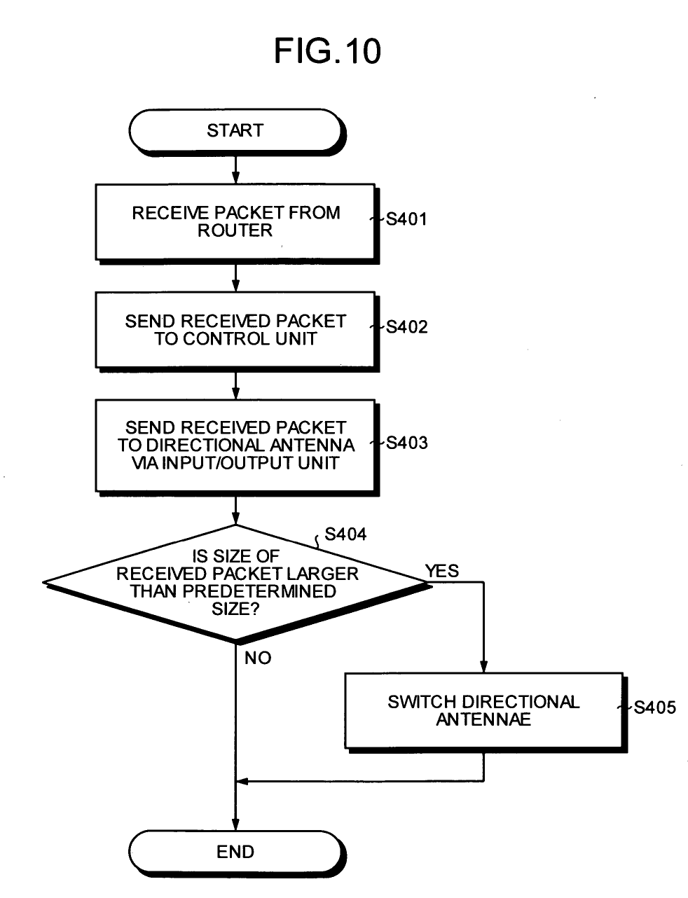

FIG. 10 is a flowchart of a processing procedure for a process of the access point 20 according to the third embodiment receiving a packet from the router 10. The process described in FIG. 10 is repeated while the access point 20 is in operation.

For the explanation of the process described in FIG. 10, a case where the access point 20 currently utilizes the directional antenna 21 will be used as an example.

The wired-LAN interface 9 receives the packet from the router 10 (step S401), and sends the received packet to the control unit 26 (step S402).

The wireless transmitting unit 26b sends the received packet to the directional antenna 21 via the input/output unit 7 (step S403). The data-size measuring unit 26a determines whether a total size of the received packet received from the router 10 is equal to or larger than a predetermined level (step S404).

When the total size of the received packet is equal to or larger than the predetermined level (step S404, Yes), the data-size measuring unit 26a sends a command to switch the directional antenna to the wireless transmitting unit 26b and the wireless receiving unit 26c, and the wireless transmitting unit 26b and the wireless receiving unit 26c switch the directional antenna to be used for packet transmission and reception (step S405).

On the other hand, when the total size of the received packet is smaller than the predetermined level (step S404, No), the process is terminated.

This means that the access point 20 is configured to receive the packet from the router 10, measure the size of the received packet, and switch the directional antenna in use whenever the measured size of the received packet is equal to or larger than the predetermined level.

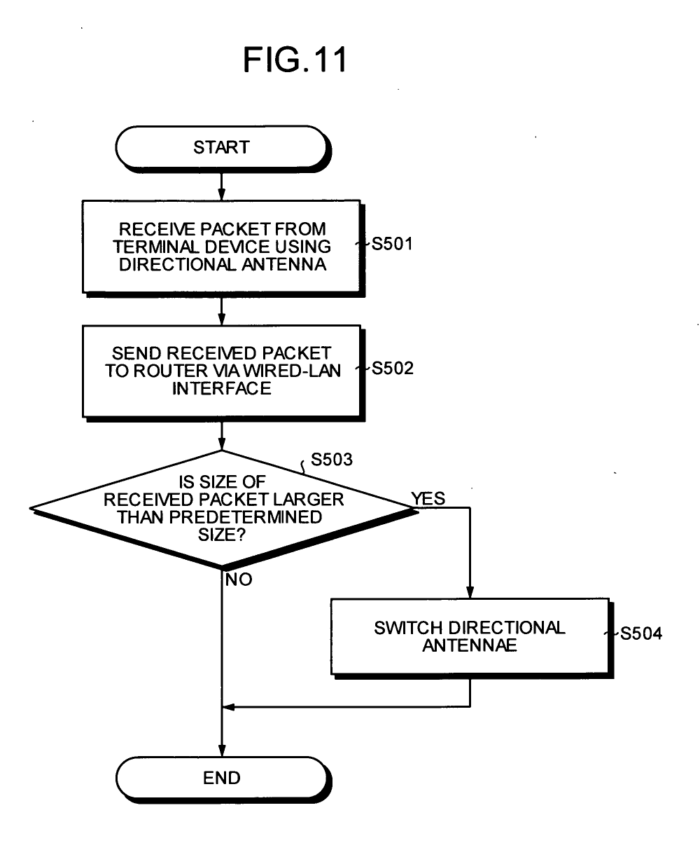

FIG. 11 is a flowchart of a processing procedure for a process of the access point 20 according to the third embodiment receiving a packet from the terminal device. The process described in FIG. 11 is repeated during the operation of the access point 20.

To explain the process indicated in FIG. 11, the case where the access point 20 currently uses the directional antenna 21 is taken as an example.

The wireless receiving unit 26c receives the packet sent from the terminal device via the input/output unit 7 by way of the directional antenna 21 (step S501). The wireless receiving unit 26c sends the received packet to the router 10 via the wired-LAN interface 9 (step S502), and the data-size measuring unit 26a determines whether the total size of the packet received from the terminal device is equal to or larger than the predetermined level (step S503).

When the total size of packet received from the terminal device is equal to or larger than the predetermined level (step S503, Yes), the data-size measuring unit 26a sends a command to switch the directional antenna the wireless transmitting unit 26b and the wireless receiving unit 26c, and the wireless transmitting unit 26b and the wireless receiving unit 26c switch the directional antenna to be used for packet reception (step S504).

On the other hand, when the total size of the received packet is smaller than the predetermined level (step S503, No), the process is terminated.

The access point 20 is configured to receive the packet from a specific terminal device, measure the size of the received packet, and switch the directional antenna currently used whenever the measured size of the packet is equal to or larger than the predetermined level.

In the access point 20 according to the third embodiment, the data-size measuring unit 26a measures the size of the packet sent from the router 10 or the terminal device, and sends the command to switch the directional antenna for transmission and reception to the wireless transmitting unit 26b and the wireless receiving unit 26c whenever the measured total size of the packet is equal to or larger than the predetermined level.

For this reason, it is essential that the terminal device be located within the packet communication area 25 to perform the data communication with the network. Hence, the data communication area can be limited to a predetermined area by alternating the directional antenna 21 and the directional antenna 22, thereby improving security in the wireless communication.

However, the present invention is not limited to this scheme, and the structure may be such that, for example, the data-size measuring unit 26a sends the command to switch the directional antenna for transmission and reception at predetermined time intervals.

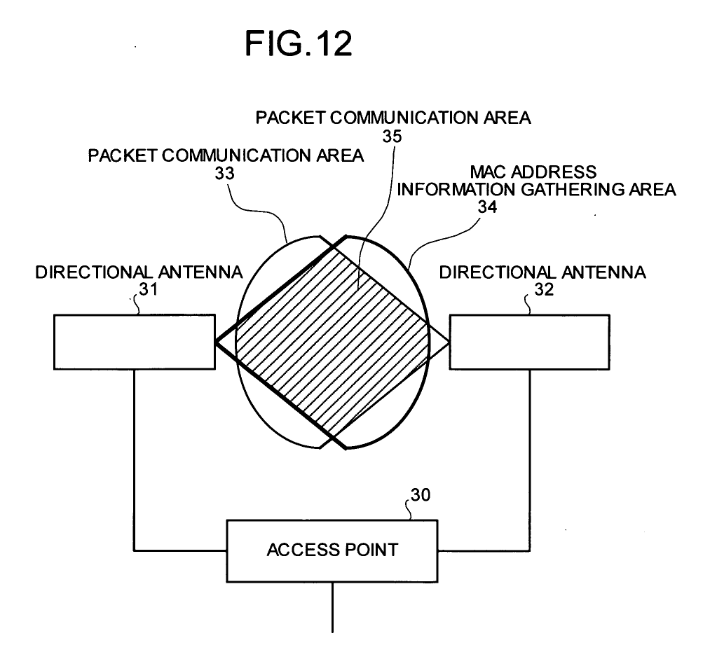

FIG. 12 is a schematic diagram for explaining a concept of an access point 30 according to a fourth embodiment of the present invention.

The access point 30 is connected to a directional antenna 31 and a directional antenna 32. The access point 30 is also connected to a network via a router (not shown).

The access point 30 first utilizes the directional antenna 31 to register a media-access-control (MAC) address that identifies a terminal device included in a MAC-address-information collecting area 34. The access point 30 detects the MAC address that identifies a terminal device to which or from which a packet is to be sent, when performing data communication between the router and the terminal device by way of the directional antenna 32.

Then, the access point 30 determines whether the same MAC address as the detected MAC address is registered. The access point 30 enables packet transmission and reception only when the same MAC address is registered.

Thus, the terminal device cannot perform the data communication with the network unless it is located within a packet communication area 35 that covers the overlapping area of the MAC-address-information collecting area 34 and a packet communication area 33.

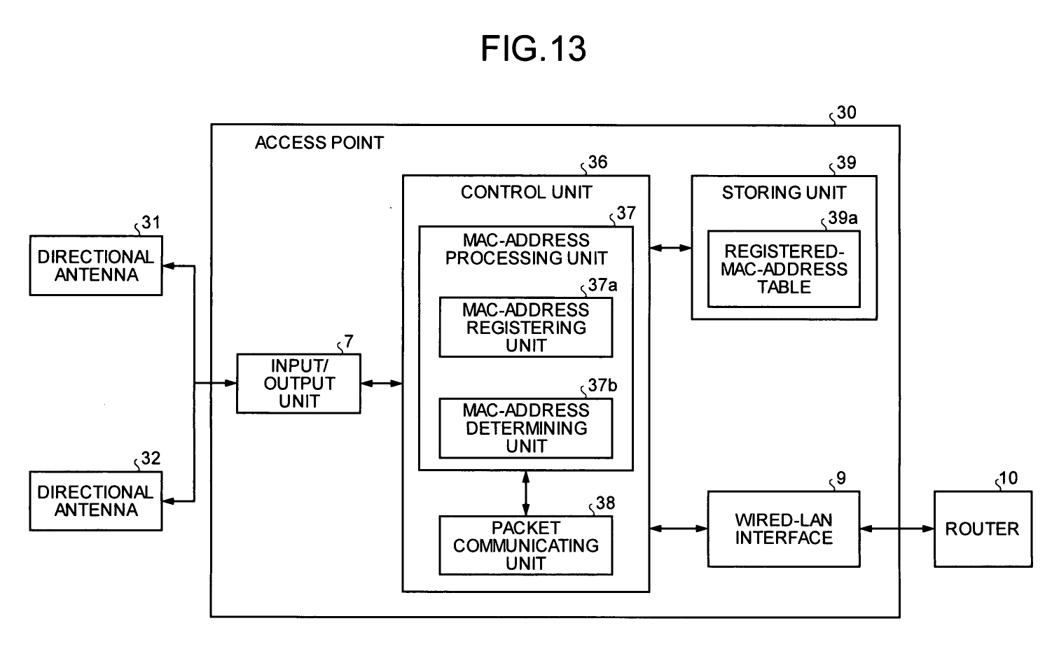

FIG. 13 is a functional block diagram of the access point 30 according to the fourth embodiment. The access point 30 is connected to the directional antenna 31, the directional antenna 32, and a router 10.

The access point 30 includes a control unit 36 and a storing unit 39. Since the rest of the structure and operations of the access point 30 are the same as the access point 1 described in the first embodiment, the same reference numerals are adopted for the same structural elements, and the explanation is omitted.

The control unit 36 includes a MAC-address processing unit 37 and a packet communicating unit 38. The MAC-address processing unit 37 includes a MAC-address registering unit 37a and a MAC-address determining unit 37b.

The MAC-address registering unit 37a uses the directional antenna 31 to receive radio waves from the terminal device located in the MAC-address-information collecting area 34 and to detect the MAC address that identifies the terminal device. Then, the MAC-address registering unit 37a registers the detected MAC address and the time at which the MAC address is detected on a registered-MAC-address table 39a of the storing unit 39.

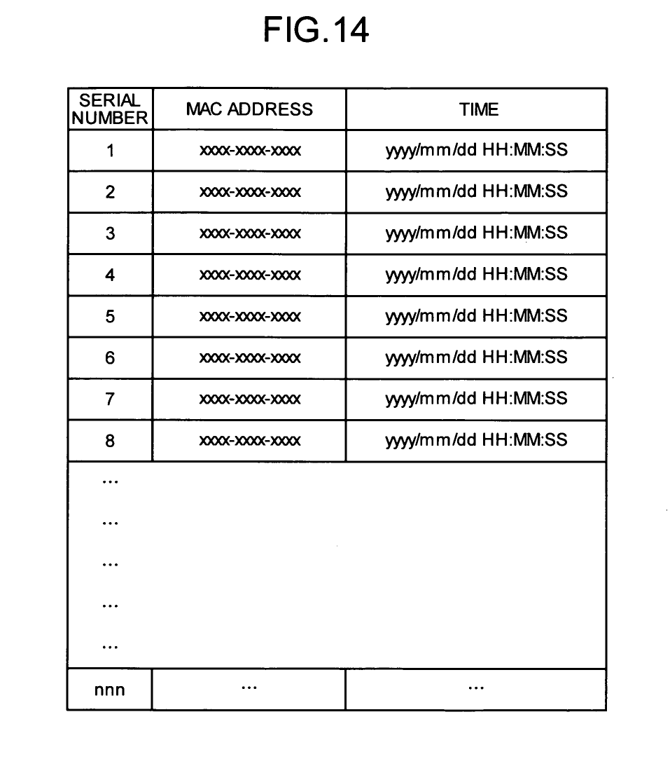

The registered-MAC-address table 39a stores a serial number, the MAC address, and the time at which the MAC address is detected, as shown in FIG. 14. The MAC-address registering unit 37a deletes a registered MAC address from the registered-MAC-address table 39a when a predetermined time has passed since the time at which the MAC address is detected.

The MAC-address determining unit 37b detects the MAC address that identifies the terminal device to which or from which the packet is sent, based on the packet information sent from the router 10 or the terminal device. Then, the MAC-address determining unit 37b determines whether the detected MAC address is registered on the registered-MAC-address table 39a. The packet transmission is permitted only when the detected MAC address is registered on the registered-MAC-address table 39a.

The packet communicating unit 38 sends the received packet information to the MAC-address determining unit 37b when receiving the packet from the router 10 or the terminal device. When the MAC-address determining unit 37b permits the packet transmission, the packet communicating unit 38 sends the packet to the directional antenna 32 or the router 10.

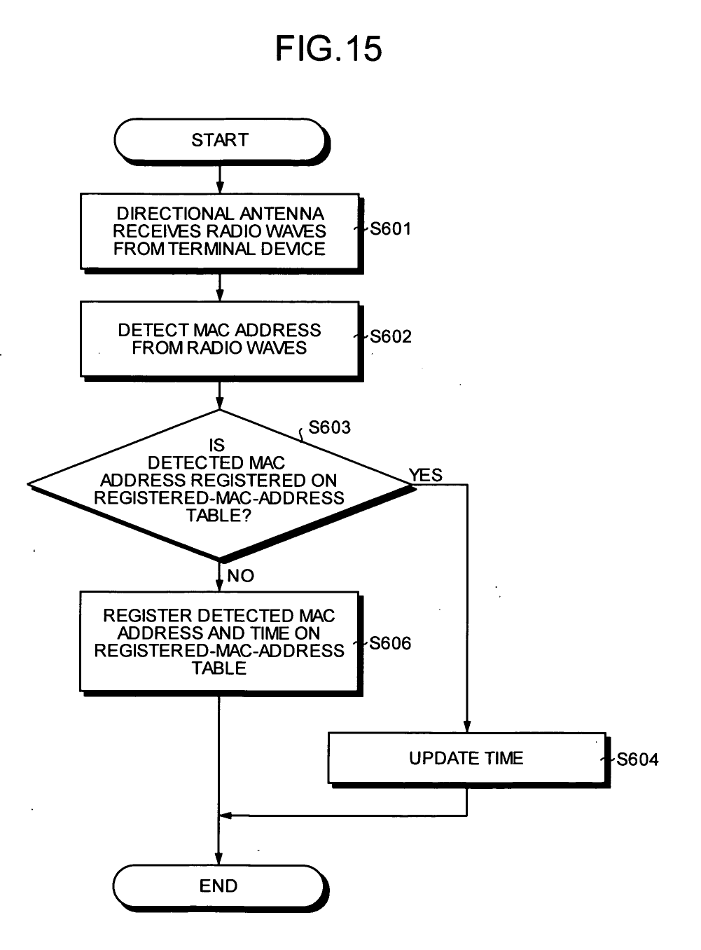

An explanation will be given for a process where the access point 30 registers the MAC address that identifies the terminal device included in the MAC-address-information collecting area 34. FIG. 15 is a flowchart of a processing procedure for the access point 30 according to the fourth embodiment registering the MAC address of the terminal device.

The directional antenna 31 receives radio waves from the terminal device (step S601). The MAC-address registering unit 37a receives the radio waves via the input/output unit 7 and the packet communicating unit 38, and detects the MAC address from the received radio waves (step S602).

The MAC-address registering unit 37a determines whether the detected MAC address is registered on the registered-MAC-address table 39a (step S603). If the detected MAC address is registered on the registered-MAC-address table 39a (step S603, Yes), the time corresponding to the detected MAC address is updated to the latest time at which MAC address is detected (step S604).

On the other hand, if the detected MAC address is not registered on the registered-MAC-address table 39a (step S603, No), the detected MAC address and the time at which the MAC address is detected are registered onto the registered-MAC-address table 39a (step S606).

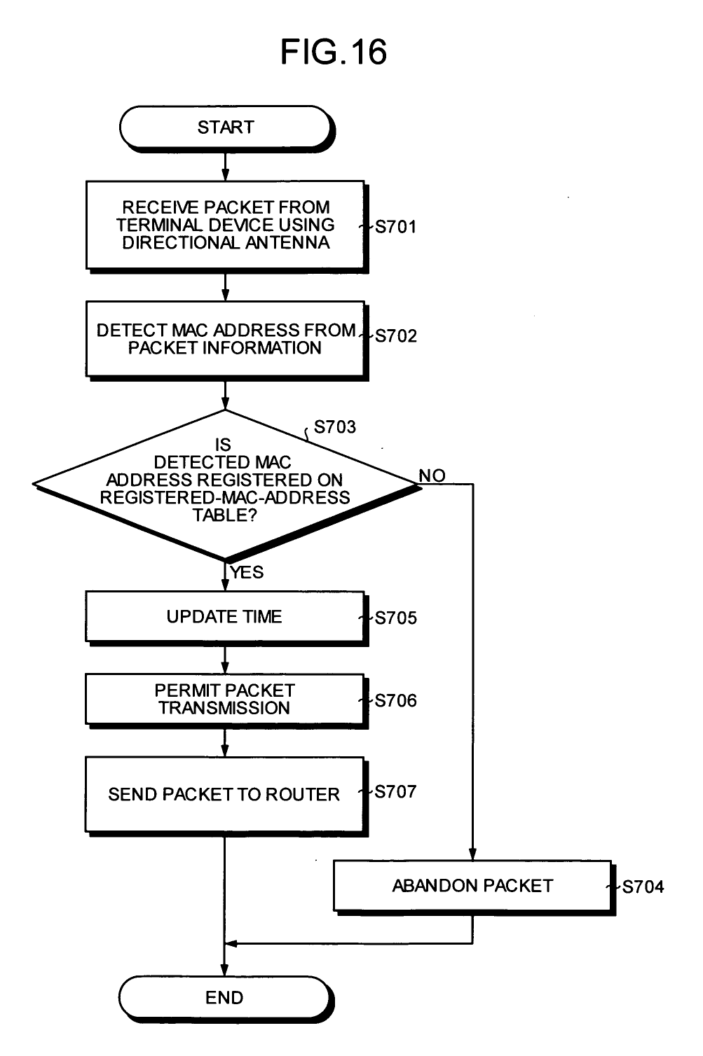

FIG. 16 is a flowchart of a processing procedure for the access point 30 according to the fourth embodiment sending a packet from the terminal device to the router 10.

The packet communicating unit 38 receives the packet by way of the directional antenna 32 (step S701), and sends packet information to the MAC-address determining unit 37b. Then, the MAC-address determining unit 37b detects the MAC address from the received packet information (step S702).

The MAC-address determining unit 37b determines whether the detected MAC address is registered on the registered-MAC-address table 39a (step S703). If the detected MAC address is not registered on the registered-MAC-address table 39a (step S703, No), the MAC-address determining unit 37b sends a command to abandon the packet to the packet communicating unit 38 (step S704).

On the other hand, if the detected MAC address is registered (step S703, Yes), the MAC-address determining unit 37b updates the time on the registered-MAC-address table 39a to the latest time at which the MAC address is detected (step S705).

The MAC-address determining unit 37b allows the packet communicating unit 38 to send the packet (step S706), and the packet communicating unit 38 sends the packet via the wired-LAN interface 9 to the router 10 (step S707).

When receiving the packet from the terminal device by way of the directional antenna 32, the access point 30 determines whether the packet should be sent to the router 10, based on the registered-MAC-address table 39a and the MAC address that identifies the terminal device from which the packet is sent. In other words, the MAC-address determining unit 37b permits the packet transmission only when the MAC address that identifies the sender terminal device is registered on the registered-MAC-address table 39a.

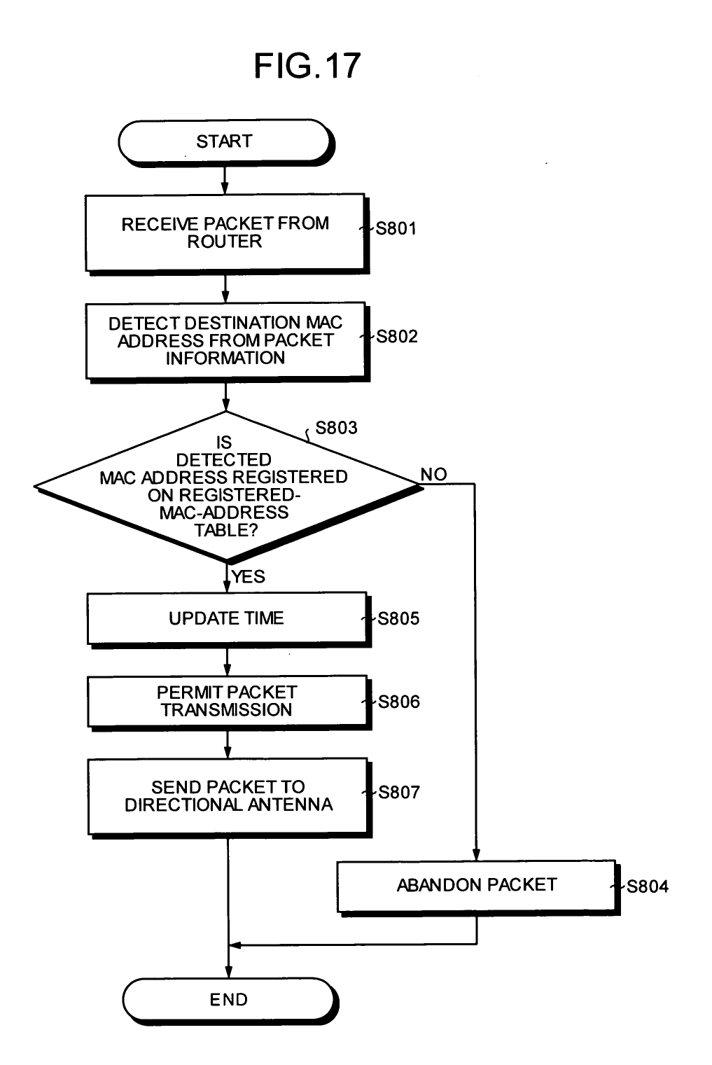

FIG. 17 is a flowchart of a processing procedure for the access point 30 according to the fourth embodiment sending a packet from the router 10 to the terminal device.

The packet communicating unit 38 receives the packet from the router 10 via the wired-LAN interface 9 (step S801). The packet communicating unit 38 sends the packet information to the MAC-address determining unit 37b. The MAC-address determining unit 37b detects the MAC address of the sender from the packet information (step S802), and determines whether the detected MAC address is registered on the registered-MAC-address table 39a (step S803).

If the detected MAC address is not registered on the registered-MAC-address table 39a (step S803, No), the MAC-address determining unit 37b sends a command to abandon the packet to the packet communicating unit 38 (step S804).

On the other hand, if the detected MAC address is registered on the registered-MAC-address table 39a (step S803, Yes), the MAC-address determining unit 37b updates the time on the registered-MAC-address table 39a to the latest time at which the MAC address is detected (step S805).

Then, the MAC-address determining unit 37b allows the packet communicating unit 38 to send the packet (step S806), and the packet communicating unit 38 sends the packet via the input/output unit 7 to the directional antenna 32 (step S807).

When receiving the packet from the router 10, the access point 30 determines whether the packet should be sent to the directional antenna 32, based on the registered-MAC-address table 39a and the MAC address that identifies the terminal device to which the packet is sent. In other words, the MAC-address determining unit 37b permits the packet transmission only when the MAC address that identifies the destination terminal device is registered on the registered-MAC-address table 39a.

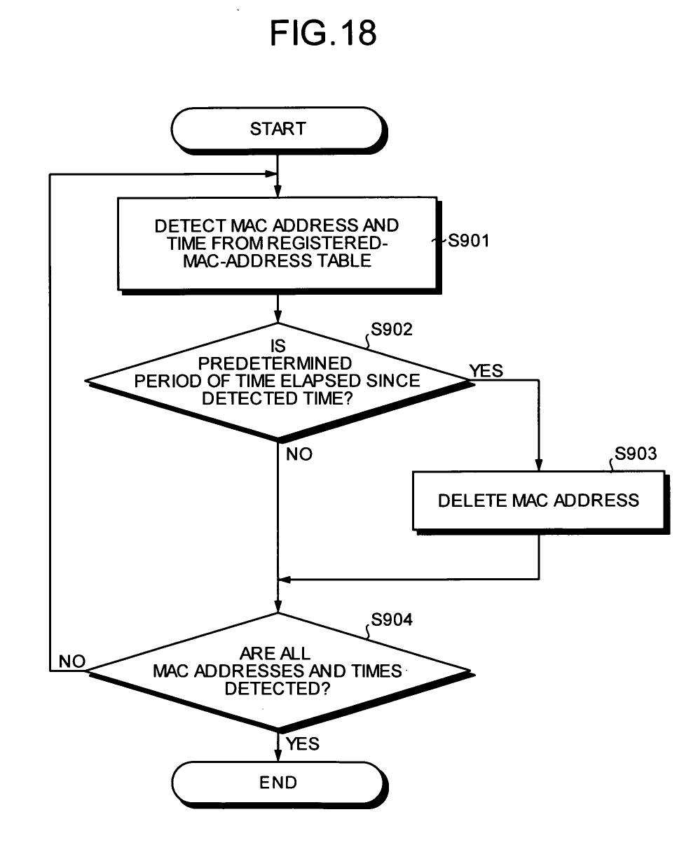

FIG. 18 is a flowchart of a processing procedure for a MAC-address registering unit 37a updating the registered-MAC-address table 39a.

The MAC-address registering unit 37a detects the MAC address and the time at which the MAC address is detected from the registered-MAC-address table 39a (step S901), and determines whether a predetermined time has passed since the time at which the MAC address is detected (step S902). If the predetermined time has passed since the time (step S902, Yes), the MAC-address registering unit 37adeletes the detected MAC address (step S903), and checks whether all the times and MAC addresses have been detected (step S904).

On the other hand, if the predetermined time has not passed since the time (step S902, No), the MAC-address registering unit 37a equally checks whether all the times and MAC addresses have been detected (step S904).

If all the MAC addresses and times have not yet been detected (step S904, No), the process proceeds to step S901, otherwise (step S904, Yes), the process is terminated.

As described above, in the access point 30 according to the fourth embodiment, the MAC-address registering unit 37a registers in advance the MAC address that identifies the terminal device located in the MAC-address-information collecting area 34, by way of the directional antenna 31.

The MAC-address determining unit 37b determines whether the MAC address that identifies the destination terminal device to which the packet that are sent from the router 10 or the sender terminal device from which the packet is sent is registered on the registered-MAC-address table 39a, and allows the packet communicating unit 38 to send or receive the packet only when the registration is completed.

In other words, the terminal device needs to be located in the packet communication area 35 where the MAC-address-information collecting area 34 and the packet communication area 33 overlap each other, to have the data communication with the network. The user can limit the data communication area of the terminal device by adopting the directional antenna 31 and the directional antenna 32, thereby improve security in the wireless communication.

Although the directional antenna 31 is utilized to receive the MAC address that identifies the terminal device while the directional antenna 32 is utilized to send the packet to and receive the packet from the terminal device according to the fourth embodiment, the structure may be designed such that the directional antenna 31 is utilized for the packet transmission and reception with the terminal device while the directional antenna 32 is utilized for reception of the MAC address that identifies the terminal device.

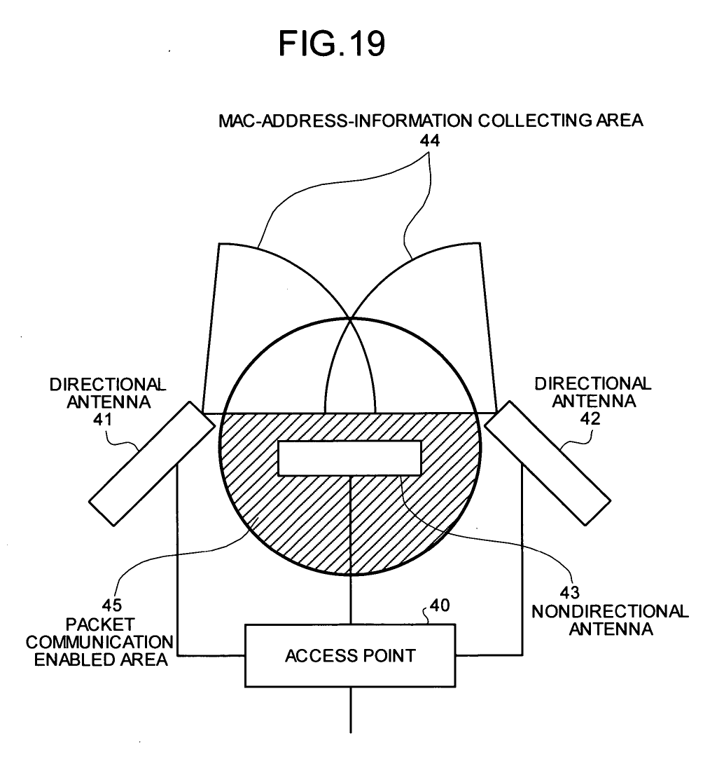

FIG. 19 is a schematic diagram for explaining a concept of an access point 40 according to a fifth embodiment of the present invention.

The access point 40 is connected to a directional antenna 41, a directional antenna 42, and a nondirectional antenna 43. The packet transmission and reception is enabled in a predetermined area and in a 360-degree field in a lateral direction by incorporating the nondirectional antenna 43 to the structure. The access point 40 is also connected to a network via a router (not shown).

The access point 40 receives radio waves in advance from a terminal device located in a MAC-address-information collecting area 44 by way of the directional antenna 41 and the directional antenna 42, detects the MAC address that identifies the terminal device from the received radio waves, and registers the detected MAC address.

When receiving the packet sent from the router or the terminal device, the access point 40 detects the MAC address of the terminal device from which or to which the packet is sent, and permits the packet transmission and reception with the terminal device by way of the nondirectional antenna 43 only when the detected MAC address is not registered.

Thus, the terminal device can achieve the data communication with the network only when the terminal device is located within a packet communication area 45 that does not overlap with the MAC-address-information collecting area 44.

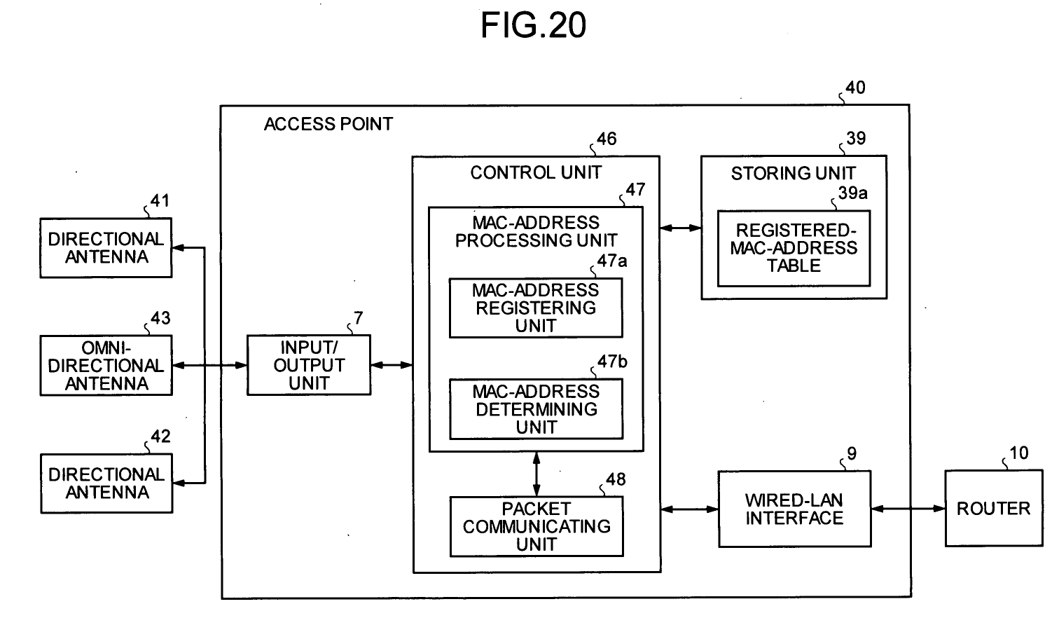

FIG. 20 is a functional block diagram of the access point 40 according to the fifth embodiment. The access point 40 is connected to the directional antenna 41, the directional antenna 42, the nondirectional antenna 43, and a router 10.

The access point 40 includes a control unit 46. Since the rest of the structure and operations of the access point 40 is the same as the access point 30 described according to the fourth embodiment, the same reference numerals are assigned to the same structural elements, and the explanation is omitted.

The control unit 46 includes a MAC-address processing unit 47 and a packet communicating unit 48. The MAC-address processing unit 47 includes a MAC-address registering unit 47a and a MAC-address determining unit 47b.

The MAC-address registering unit 47a receives radio waves from the terminal device included in the MAC-address-information collecting area 44 by way of the directional antenna 41 and the directional antenna 42, and detects the MAC address that identifies the terminal device. Then, the MAC-address registering unit 47a registers the detected MAC address and the time at which the MAC address is detected on the registered-MAC-address table 39a of the storing unit 39. The MAC-address determining unit 47b detects the MAC address that identifies the terminal device from which or to which the packet is sent, from the packet information sent from the router 10 or the terminal device. Then, the MAC-address determining unit 47b determines whether the detected MAC address is registered on the registered-MAC-address table 39a, and permits the packet transmission and reception by way of the nondirectional antenna 43 only when the detected MAC address is not registered on the registered-MAC-address table 39a.

When receiving the packet from the router 10 or the terminal device, the packet communicating unit 48 sends the received packet information to the MAC-address determining unit 47b. The packet communicating unit 48 then sends the packet to the nondirectional antenna 43 or the router 10 when the MAC-address determining unit 47b permits the packet transmission and reception.

As described above, in the access point 40 according to the fifth embodiment, the MAC-address registering unit 47a registers in advance the MAC address that identifies the terminal device located in the MAC-address-information collecting area 44 by way of the directional antenna 41 and the directional antenna 42. The MAC-address determining unit 47b determines whether the same MAC address as the MAC address of the destination terminal device to which the packet is sent or the sender terminal device from which the packet is sent is registered on the Registered-MAC-address table 39a.

The MAC-address determining unit 47b permits the packet transmission and reception only when the detected MAC address is not registered on the Registered-MAC-address table 39a, and the packet communicating unit 48 sends and receives the packet by way of the nondirectional antenna 43.

In other words, the terminal device needs to be included in the packet communication area 45 that does not overlap with the MAC-address-information collecting area 44. Thus, the user can limit the data communication area of the terminal device by adopting the directional antenna 41, the directional antenna 42, and the nondirectional antenna 43, and improve security in the wireless communication.

As explained above, according to the present invention, the terminal device can perform the wireless communication with the wired-network only in the overlapping area of the transmission enabled area and reception enabled area, while the wireless communication with the wired-network is not permitted in an area other than the overlapping area. Therefore, the present invention has an advantage that the wirelessly communication area can be limited to a predetermined area, and that security can be improved in the wireless communication.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication relay apparatus that relays a wireless communication for a communication device, the communication relay apparatus comprising:
a wireless transmitting unit that transmits data to the communication device via a transmission antenna; and
a wireless receiving unit that receives data from the communication device via a reception antenna of which a reception area overlaps partially with a transmission area of the transmission antenna.

2. The communication relay apparatus according to claim 1, wherein
the transmission antenna includes a plurality of antennas, and
transmission areas of the antennas are partially overlapped each other.

3. The communication relay apparatus according to claim 2, wherein
at least one of the transmission antennas is used as the reception antenna.

4. The communication relay apparatus according to claim 1, wherein
each of the transmission antenna and the reception antenna includes a plurality of antennas,
wireless communication areas of the antennas are partially overlapped each other, and
the communication relay apparatus further comprises an antenna switching unit that switches the antennas as the transmission antenna and the reception antenna.

5. The communication relay apparatus according to claim 4, wherein
the antenna switching unit measures a size of the data transmitted by the wireless transmitting unit, and switches the transmission antenna when the measured size of the data is equal to or larger than a predetermined size.

6. The communication relay apparatus according to claim 4, wherein
the antenna switching unit measures a size of the data received by the wireless receiving unit, and switches the reception antenna when the measured size of the data is equal to or larger than a predetermined size.

7. The communication relay apparatus according to claim 4, wherein
the antenna switching unit measures a time, and switches either one of the transmission antenna or the reception antenna based on the measured time.

8. The communication relay apparatus according to claim 1, wherein
the communication device includes an identifier that identifies the communication device, and
the communication relay apparatus further comprises a relay determining unit that determines whether to permit a relay of the wireless communication for the communication device based on the identifier.

9. The communication relay apparatus according to claim 8, further comprising:
an identification information storing unit that stores the identifier of the communication device for which the relay of the wireless communication is permitted.

10. The communication relay apparatus according to claim 9, further comprising:
an identifier registering unit that registers the identifier of a new communication device for which the relay is to be permitted on the identification information storing unit.

11. The communication relay apparatus according to claim 10, wherein
the identification information storing unit further stores a time at which the identifier of the new communication device is registered as a registration time, and deletes the identifier for which a predetermined time has passed since the registration time.

12. The communication relay apparatus according to claim 11, wherein
the identification information storing unit updates the registration time with a time at which the wireless communication is relayed for the communication device of which the identifier is stored.

13. A method of relaying a wireless communication for a communication device, the method comprising:
transmitting data to the communication device via a transmission antenna; and
receiving data from the communication device via a reception antenna of which a reception area overlaps partially with a transmission area of the transmission antenna.

14. The method according to claim 13, wherein
the transmission antenna includes a plurality of antennas, and
transmission areas of the antennas are partially overlapped each other.

15. The method according to claim 14, wherein
at least one of the transmission antennas is used as the reception antenna.

16. The method according to claim 13, wherein
each of the transmission antenna and the reception antenna includes a plurality of antennas,
wireless communication areas of the antennas are partially overlapped each other, and
the method further comprises switching the antennas as the transmission antenna and the reception antenna.

17. A computer-readable recording medium that stores a computer program for relaying a wireless communication for a communication device, wherein
the computer program causes a computer to execute:
transmitting data to the communication device via a transmission antenna; and
receiving data from the communication device via a reception antenna of which a reception area overlaps partially with a transmission area of the transmission antenna.

18. The computer-readable recording medium according to claim 17, wherein
the transmission antenna includes a plurality of antennas, and
transmission areas of the antennas are partially overlapped each other.

19. The computer-readable recording medium according to claim 18, wherein
at least one of the transmission antennas is used as the reception antenna.

20. The computer-readable recording medium according to claim 17, wherein
each of the transmission antenna and the reception antenna includes a plurality of antennas,
wireless communication areas of the antennas are partially overlapped each other, and
the method further comprises switching the antennas as the transmission antenna and the reception antenna.
